(19) United States
(12) Patent Application Publication
(10) Pub. No.: US 2019/0135323 A1
(43) Pub. Date: May 9, 2019

(54) Convertible Stroller

(71) Applicant: Tamooz C.S. Ltd., Kfar Saba (IL)

(72) Inventors: Amit Avigdor, Kibbutz Bachan (IL); Hagai Harduff, Binyamina (IL); Ori Levin, Petah Tikva (IL); Eyal Shmueli, Reut (IL)

(73) Assignee: Tamooz C.S. Ltd., Kfar Saba (IL)

(21) Appl. No.: 16/124,504

(22) Filed: Sep. 7, 2018

Related U.S. Application Data
(63) Continuation-in-part of application No. PCT/IL2017/050273, filed on Mar. 6, 2017.

(30) Foreign Application Priority Data
Mar. 7, 2016 (IL) 24465

(51) Int. Cl. B62B 7/12; B62B 7/06; B62B 9/10; B62B 9/12; B62B 9/20

(52) U.S. Cl. CPC B62B 7/12; B62B 7/062; B62B 9/104; B62B 2206/006; B62B 9/20; B62B 2205/06; B62B 9/12

(57) ABSTRACT

A foldable convertible stroller for children, converting between stroller (concealed-stroller and open-stroller), playpen (full or partial), and folded configurations, featuring four U-shaped chassis support bars movable about joint side-hubs into a raised deployed position when fully expanded, when in a concealed-stroller or the playpen configuration, or a lowered deployed position when partially expanded, when in an open-stroller configuration, and foldable into a folded configuration by collapsing into a nested arrangement. The stroller further features a foldable base support, a circumferential main curtain spanning between the base and the upper front and rear support bars for surrounding the stroller in a playpen configuration, an optional foldable rest, and an optional handle portion of an upper rear support bar that allows selectively erecting and folding. A complementary method for converting the stroller between the configurations is also provided.

### BACKGROUND OF THE INVENTION

### Field of the Invention

The disclosed invention generally relates to strollers and playpens and more specifically, a stroller that can be converted between a regular stroller, a playpen and being folded.

### Description of the Related Art

Strollers and similar devices have been used for baby and child transportation for decades, designed to allow for an easier way to transport children and allow for a more flexible lifestyle. A stroller will usually have a seating component, sometimes allowing for multiple children, generally settled on an arrangement of wheels with a handle to push or pull. A playpen, another device, that allows for children to stand or sit within a, usually, small, enclosed space. This is typically a piece of immobile furniture with side safety bars or latticework, and some playpens are also portable and may be made of plastic, mesh or nylon sides. Some strollers or playpens may be collapsible and allow for transportation or storage in this collapsed state. Some allow for the removal of a seat, or reconfiguration in different orientations with a standalone seat.

U.S. Pat. No. 5,125,674 to Manuszak, entitled “Unitary Infant Care Apparatus,” discloses a unitary infant care apparatus, namely—a playpen, wherein the baby seat is able to be either in a horizontal or a vertical position. The playpen further has the ability to be wheeled or collapsed and carried between locations.

US Publication No. 2003/209,883 to Hsia, entitled “Sports Utility Stroller,” discloses a collapsible baby carriage. The baby carriage consists of a playpen sitting on top of four wheels for transportation. The carriage is collapsible along the base of the carriage.

US Publication No. 2016/0016601 to Velichko, entitled “Convertible Baby Stroller Assembly,” discloses stroller existing as a walled playpen with an option to aperture for the legs of a child on the front wall. The playpen is coupled to a frame including wheels and maintains the ability to collapse. The frame includes a handle which allows the stroller to be selectively moved.

U.S. Pat. No. 9,221,487 to Doucette et al., entitled “Convertible Stroller Seat” discloses a child seat wherein the seat and the seat back are movable at the seat bight to allow for a lying flat and a sitting upright position. The seat can be placed into a baby carriage to allow for mobility.

### SUMMARY OF THE INVENTION

According to one aspect of the disclosed technique there is thus provided a foldable convertible stroller for children, converting between various stroller, playpen, and folded configurations. The stroller features four U-shaped chassis support bars, the open ends of which bars are supported at, and movable about, joint side-hubs, and which bars are foldably collapsible about the joint side hubs into a nested arrangement when the stroller in the folded configuration. The four U-shaped chassis support bars include an upper front support bar, an upper rear support bar, a lower front support bar, and a lower rear support bar. The convertible stroller further features a base support enclosing a covering material, the support being coupled to the lower front support bar and the lower rear support bar, is optionally hingedly coupled to the lower front support bar and the lower rear support bar and is folded, optionally about an intermediate hinge, when the stroller in a folded configuration.

The upper rear support bar, lower front support bar and lower rear support bar are expandable about the joint side hubs into a fully deployed position, when the convertible stroller is in the stroller configuration or the playpen configuration. When the stroller is in the stroller configuration or the playpen configuration, the upper front support bar is selectively expandable about the joint side hubs into one of two positions: a raised deployed position when fully expanded to render the stroller in a closed concealed stroller configuration or a full playpen configuration; and a lowered position to render the stroller in an open stroller configuration or in a partial playpen configuration.

The stroller further features a circumferential main curtain spanning between the base and the upper front and upper rear support bars for surrounding the stroller in a playpen configuration or the concealed stroller configuration.

In some embodiments the joint side-hubs may feature joint side-hinges.

Optionally, the open ends of the U-shaped bars are hinged at and rotatable about the joint side-hubs, and foldably collapsible there about into a nested arrangement when the stroller in the folded configuration. Accordingly, the upper rear support bar, lower front support bar and lower rear support bar are rotatably expandable about the joint side hubs into a fully deployed position when the stroller is in the stroller configuration or the playpen configuration, and when the stroller is in the stroller configuration or the playpen configuration, the upper front support bar is selectively rotatably expandable about the joint side hubs into a raised deployed position when fully expanded to render the stroller in a concealed-stroller configuration or in a full playpen configuration, and/or a lowered deployed position when partially expanded while neighbouring the base, to render the stroller in an open-stroller configuration or in a partial playpen configuration.

Further optionally, the open ends of the upper rear support bar, lower front support bar, and lower rear support bar, are hinged at and rotatable about the joint side-hubs, and foldably collapsible there about into a nested arrangement when the stroller in the folded configuration, and rotatably expandable there about into a fully deployed position when the stroller is in the stroller configuration or the playpen configuration. However, the upper front support bar is telescopically expandable from the lower rear support bar into a raised deployed position when fully expanded to render the stroller in a playpen configuration, and is telescopically collapsible to the lower rear support bar into a nested arrangement when the stroller is in the folded configuration, or an open-stroller configuration.

The stroller may further include a foldable rest, such as a hammock rest or seat. In a preferred embodiment, the upper rear support bar includes a seat support bridge and the hammock rest has a U-shape seat lifting bar, hinged at its ends rear corners of the base, or to corners of the lower rear support bar. The hammock rest may further include a sheet extending between the seat lifting bar and the seat support bridge, wherein the sheet includes a cavity disposed in the upper section thereof, and the cavity has a seat bottom and a seat back support. The hammock rest is then deployed into a sitting mode when the seat lifting bar is lowered to the base, when the stroller is in the stroller configuration, and is folded when the seat lifting bar is raised to an uppermost position, when the stroller is in the playpen configuration or the folded configuration. The seat lifting bar may include a locking mechanism for locking into a sitting mode when the seat lifting bar is lowered to the base, or into the seat folded mode when the seat lifting bar is raised to an uppermost position. The rest may include an adjustable security harness, a double seat, a collapsible front gripping handle bar, or a removable rest.

Optionally, the upper rear support bar may include a handle portion pivotally hinged about side handle hinges, for allowing selective erection of the upper rear support bar into a handle position, at a selected angle, when the stroller is in the stroller configuration or the playpen configuration, and folding into a compacted position when the stroller is in the folded configuration. The handle portion may be configured as a carrying handle for carrying the stroller in the folded configuration, or as a retractable handle portion for adapting to the height of the user, and may include a safety latch.

The joint hubs may include a locking mechanism configured to hold the support bars in locked position.

The stroller may further include left and right complementary curtains for concealing upper gaps between the upper support bars. The main curtain or the complementary curtains may be removably attachable by a zipper, a set of corresponding fastening strips, a pair of magnets, an interlocking buckle, or a string, and include a material such as translucent, mesh, transparent fabric, netted, or liquid resistant material, feature child gripping or climbing means, or a closable rear access aperture.

In a preferred embodiment, two front wheels may be coupled to the front of the base support or to the lower front support bar, and two rear wheels may be coupled to the base support or the lower rear support bar. The wheels may include a locking mechanism for selectively preventing wheel roll. The front wheels may be spaced apart from the rear wheels when the stroller is in the folded configuration, allowing compact folding thereof.

The stroller may further include a carrycot, a bassinet, a canopy, a base mattress, or a rear bag, all of which can be detachably fastened to the convertible stroller.

According to another aspect of the disclosed technique, there is provided a method for converting a convertible stroller for children between various stroller, playpen and folded configurations. The method includes moving U-shaped chassis lower front, lower rear and upper rear support bars, whose ends are movably connected to joint side-hubs to a fully deployed position when fully expanded about the joint side hubs for rendering the convertible stroller in an unfolded configuration, and thereby unfolding of a base support, preferably about an intermediate hinge, wherein the support is coupled to the lower front support bar and the lower rear support bar. The method further includes setting a U-shaped chassis upper front support bar into one of two positions: a raised position for forming a fully erect playpen configuration or a concealed-stroller configuration, or a lowered position for forming a partial playpen configuration or an open-stroller configuration.

The joint side-hubs may include joint side-hinges.

The procedure of moving may include rotating lower front, lower rear and upper rear U-shaped chassis support bars, whose ends are hinged at, and rotatable about, said joint side-hubs, to a fully deployed position when fully expanded about the joint side hinges for rendering the convertible stroller in an unfolded configuration.

The procedure of setting may include rotating a U-shaped chassis upper front support bar, whose ends are hinged at, and rotatable about, the joint side-hubs, into one of two expanded positions: a raised position for forming a fully erect playpen configuration or a concealed-stroller configuration; and a lowered position for forming an open-stroller configuration.

Next, optionally unfolding of a handle portion hinged to the upper rear support bar. Optionally, a deployable rest may then be deployed with the lowering of a U-shaped seat lifting bar, hinged at the ends of said seat lifting bar for allowing resting of a child when in the stroller configuration. Reversing the above procedures will allow for folding the convertible stroller.

### BRIEF DESCRIPTION OF THE DRAWINGS

The present invention will be understood and appreciated more fully from the following detailed description taken in conjunction with the drawings in which:

FIG. 1 is an isometric illustration of a convertible stroller in an open stroller configuration, constructed and operated in accordance with one embodiment of the present invention;

FIG. 1A is a front view illustration of the stroller structure of FIG. 1 in an open stroller configuration.

FIG. 2 is an isometric illustration of the stroller structure of FIG. 1 in a playpen with side access configuration.

FIG. 3 is an isometric illustration of the stroller structure of FIG. 1 in a full playpen configuration.

FIG. 4 is an isometric illustration of the stroller structure of FIG. 1 in an open playpen configuration.

FIG. 5 is an isometric illustration of the stroller structure of FIG. 1 in an enclosed concealed stroller configuration.

FIG. 6 is an isometric illustration of the stroller structure of FIG. 1 in an open stroller configuration with an extended flat rest configuration adapted for laying position.

FIG. 7 is a series of side view illustrations of various configurations of the stroller structure of FIG. 1 demonstrating the ease of reconfiguration.

FIG. 8 is an isometric illustration of the stroller structure of FIG. 1 in a folded configuration;

FIG. 9 is a flow chart of a method for converting a convertible stroller for children, between stroller, playpen and folded configurations, operative in accordance with an embodiment of the present invention;

FIG. 10 is a side view illustration of a joint hinge of the stroller structure of FIG. 1, divided by quadrants for locking hinged support bars;

FIG. 11 is a side view illustration of the stroller structure of FIG. 1 demonstrating a conversion from a full playpen configuration to a folded configuration, using the method of FIG. 9;

FIG. 12 is an isometric illustration of the stroller structure of FIG. 1 featuring a canopy;

FIG. 13 is an isometric illustration of the stroller structure of FIG. 1 featuring a bassinet;

FIGS. 14A, 14B, 14C, and 14D illustrate another embodiment of a convertible stroller, constructed and operative in accordance with the invention. FIG. 14A is a side view illustration of the stroller in an open stroller configuration; FIG. 14B is an isometric illustration of the stroller in an open stroller configuration; FIG. 14C is a side view illustration of the stroller in a playpen configuration; and FIG. 14D is an isometric illustration of the stroller in a playpen configuration;

FIGS. 15A, 15B, 15C, and 15D illustrate a further embodiment of a convertible stroller, constructed and operative in accordance with the invention. FIG. 15A is a side view illustration of the stroller in an open stroller configuration; FIG. 15B is an isometric illustration of the stroller in an open stroller configuration; FIG. 15C is a side view illustration of the stroller in a playpen configuration; and FIG. 15D is an isometric illustration of the stroller in a playpen configuration; and

FIGS. 16A, 16B, 16C, 16D, and 16E illustrate a further embodiment of a convertible stroller, constructed and operative in accordance with the invention. FIG. 16A is a side view illustration of the stroller in an open stroller configuration; FIG. 16B is an isometric illustration of the stroller in an open stroller configuration; FIG. 16C is an isometric illustration of the stroller in an open stroller configuration with its seat folded for allowing conversion into playpen configuration; FIG. 16D is a side view illustration of the stroller in a playpen configuration; and FIG. 16E is an isometric illustration of the stroller in a playpen configuration.

### DETAILED DESCRIPTION OF THE EMBODIMENTS

The present invention overcomes the disadvantages of the prior art by providing a system and method for a convertible stroller, foldable between several different configurations. In broader aspects, the convertible stroller is composed of a system of U-shaped bars, which are connected by joint side-hubs (or cores), e.g., movably coupled to a pair of side hubs, or hinged to and rotatable about a pair of joint hinges (or hinge units) to allow access between configurations of a stroller (concealed-stroller or open-stroller) to a playpen, as well as a folded configuration. Preferably, the stroller includes a foldable rest, interchangeably termed herein below as a “seat”, “rest”, “hammock” or combination thereof, that may be lowered for seating, extended for laying or crouching, or raised in a storage position among each of the configurations. Generally, the present invention may be used to transport a child, children and/or other items with configurations ranging from a folded configuration to various playpen and stroller configurations.

In accordance with embodiments of the invention, the foldable convertible stroller for children, is converting between various stroller, playpen, and folded configurations. The convertible stroller includes U-shaped chassis support bars which include an upper front support bar, an upper rear support bar, a lower front support bar, and a lower rear support bar. The open ends of the U-shaped bars are connected at and movable about joint side-hubs, and are foldably collapsible about the joint side hubs into a nested arrangement when the stroller is in the folded configuration. A base support is coupled to the lower front support bar and the lower rear support bar, enclosing a covering material and is folded when the stroller is in the folded configuration. The upper rear support bar, lower front support bar and lower rear support bar are expandable about the joint side hubs into a fully deployed position when the stroller is in the stroller configuration or the playpen configuration.

When the stroller is in the stroller configuration or the playpen configuration, the upper front support bar is selectively expandable about the joint side hubs into a raised deployed position when fully expanded to render the stroller in a concealed-stroller configuration or in a full playpen configuration; and/or into a lowered position to render the stroller in an open-stroller configuration or in a partial playpen configuration. A circumferential main curtain spans between the base and the upper front and upper rear support bars and surrounds the stroller in the playpen configuration or the concealed stroller configuration.

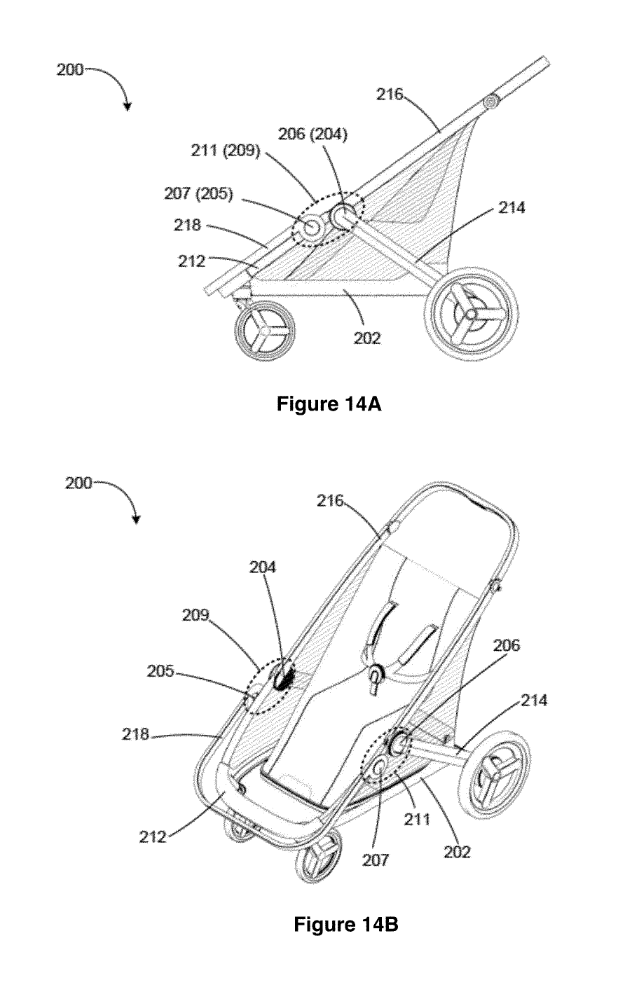

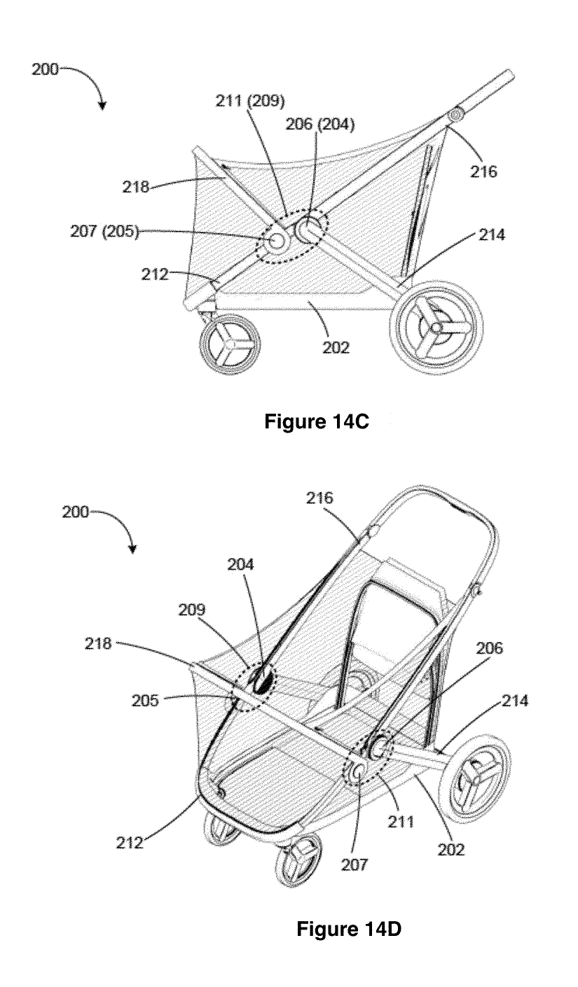

Examples of side-hinges which are not joint hinges, and are dispersed over a central side-hub or core, and of connection structures other than hinges, are described hereinbelow with reference to FIGS. 14A to 16E.

In accordance with an embodiment of the invention, the open ends of the U-shaped bars are hinged at and rotatable about the joint side-hubs, and are foldably collapsible about the joint side hubs into a nested arrangement when the stroller is in the folded configuration. The upper rear support bar, lower front support bar and lower rear support bar are rotatably expandable about the joint side hubs into a fully deployed position when the stroller is in the stroller configuration or the playpen configuration. When the stroller is in the stroller configuration or the playpen configuration, the upper front support bar is selectively rotatably expandable about the joint side hubs into a raised deployed position when fully expanded to render the stroller in a concealed-stroller configuration or in a full playpen configuration, and/or into a lowered deployed position when partially expanded while neighbouring the base, to render the stroller in an open-stroller configuration or in a partial playpen configuration. The joint side hubs may include joint side hinges.

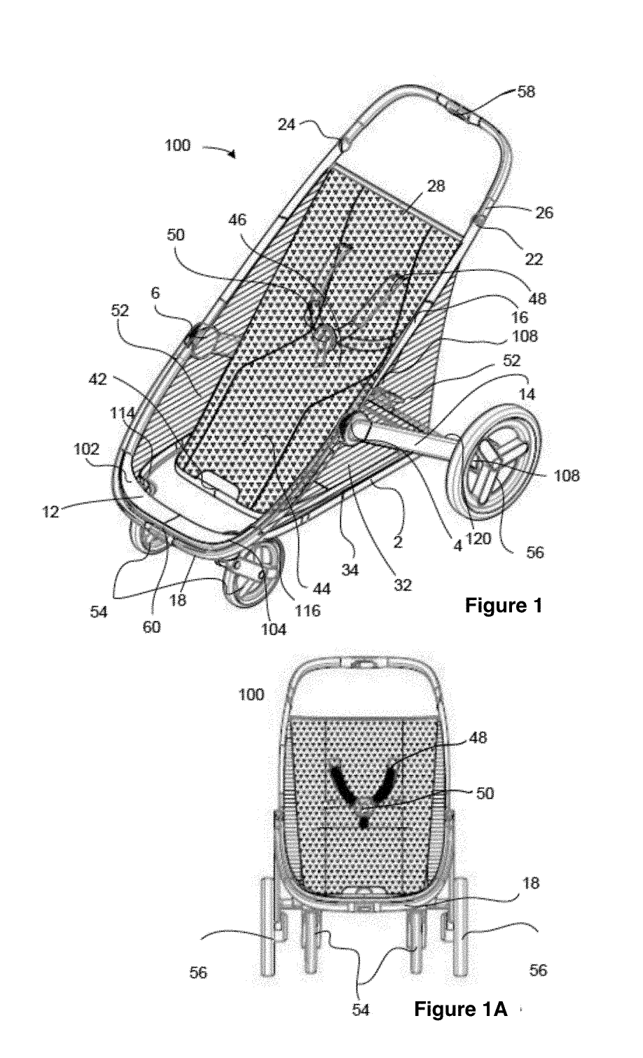

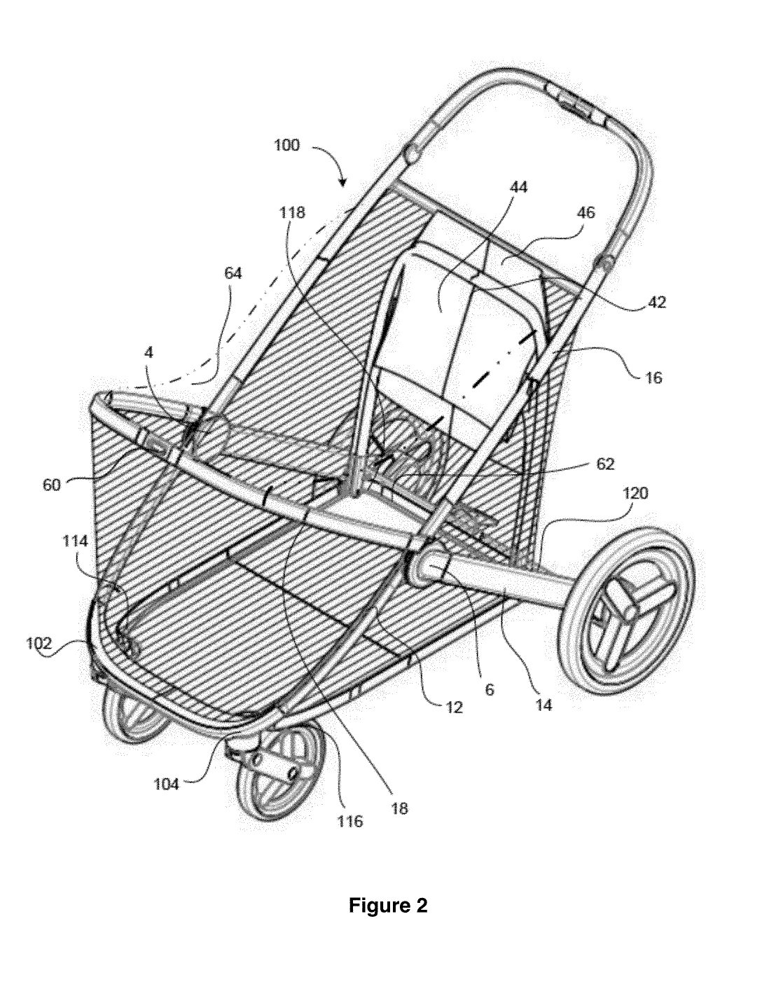

Reference is now made to FIG. 1, which is a schematic illustration of a convertible stroller, generally referenced 100, in an open stroller configuration. Reference is also made to FIGS. 2 to 6, 8, 12, and 13, in which similar numerals designate similar parts. Convertible stroller 100 includes a base support 2, four U-shape chassis support bars 12, 14, 16, and 18, each having two ends hinged at and about a pair of central left and right joint side-hinge units 4 and 6, respectively (“joint” in this context refers to simultaneously serving as a single common hinge of the four U-shaped bars). The four u-shape chassis support bars are radially oriented around central hinge units 4 and 6 (or hinges 4, 6), and include lower front support bar 12, lower rear support bar 14, upper rear support bar 16 and upper front support bar 18. Upper rear support bar 16 is hinged at two sides with a pair of minor left and right “handle” side-hinges 22 and 24, respectfully, creating a handle portion 26. A seat support bridge 28 is located proximate to the minor left and right side-hinges 22, 24. A safety or braking mechanism 58 may be coupled to handle portion 26.

Base support 2 is a support bar, enclosing a covering-material 32. Base support 2 may be folded about an intermediate hinge 34. The material of covering-material 28 may be a strong material, e.g., a taught fabric, a board or a plastic sheet, that is configured to support standing and jumping children or other objects and may incorporate padding or cushioning for safety and increased strengthening. Covering-material 28 may also be removable, allowing for washing and replacing, and a removable mattress or cushion may be placed thereon. With intermediate hinge 30, base support 2 may be folded for a folded configuration, exemplifying means for the folding of base support 2. To increase the safety of convertible stroller 100, intermediate hinge 30 may have an additional locking and unlocking device to keep base support 2 in the desired configuration.

Left and right joint side-hinge units 4, 6 are centrally located on either side of convertible stroller 100 about which each support bar 12, 14, 16, and 18 is able to rotate. Lower front support bar 12 is connected at their open side, respectively, namely—at the ends thereof, to left and right joint side-hinges 4, 6, and when in an unfolded configuration, corners 102, 104 of lower front support bar 12 are orientated toward the front of support base 2. Corners 106, 108 of lower rear support bar 14 are oriented toward corners 118, 120 of base support 2. It will be appreciated that the term “end” as used herein refers to one of two ends of the open side of a U-shaped bar and the term “corner” as used herein refers to any form of the bent or curved closed side of a U-shaped bar. For Example, from the shape of the letter “U,” the ends are designated as the two points at the top and a corner being the bottom part. It is noted, that a curved end may differ in the actual shape and embodied shape, thusly the letter “U” is simply used as a reference and may embody a different shape or configuration. The coupling between support bars may be achieved, for instance, with a screws, washers, and bolts.

Following lower front support bar 12 in a counter-clockwise order is lower rear support bar 14, upper rear support bar 16 and upper front support bar 18. Lower front support bar 12, lower rear support bar 14 and upper rear support bar 16 may each be rotated around left and right joint side-hinges 4, 6 to either a folded configuration or an unfolded configuration. Upper front support bar 18 may be rotated into one of three positions, differentiating an open or enclosed (“concealed”) position of a stroller and playpen configuration as well as a folded configuration. While in the current embodiment, each support bar may rotate around the left and right joint side-hinges 4, 6, there may be an embodiment wherein one support bar remains stationary and the other three rotate in relation to the stationary support bar to form each configuration.

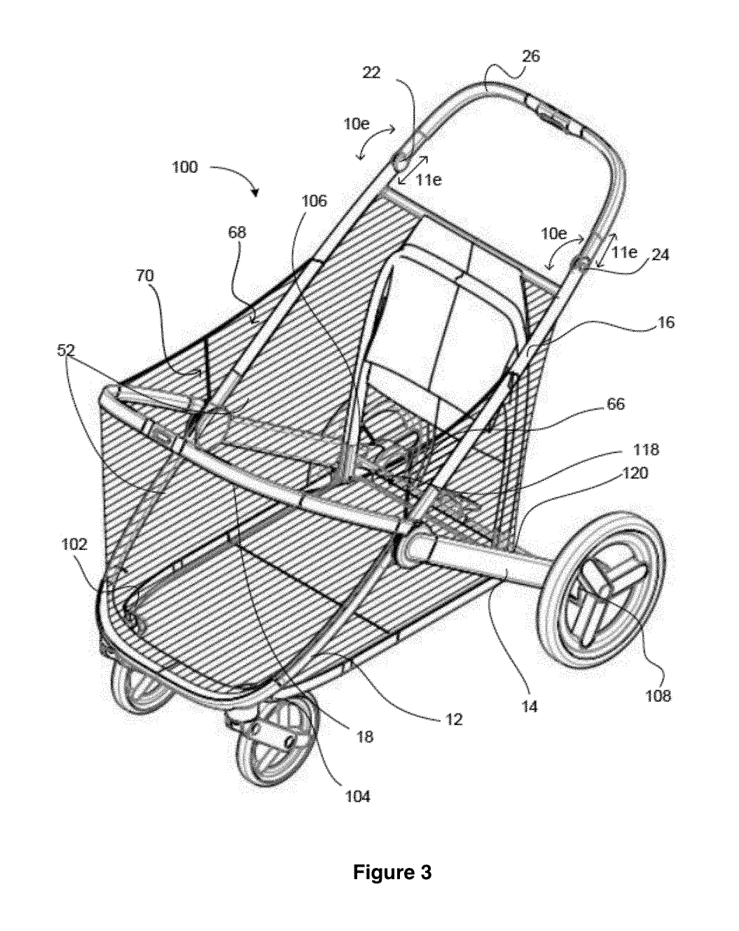

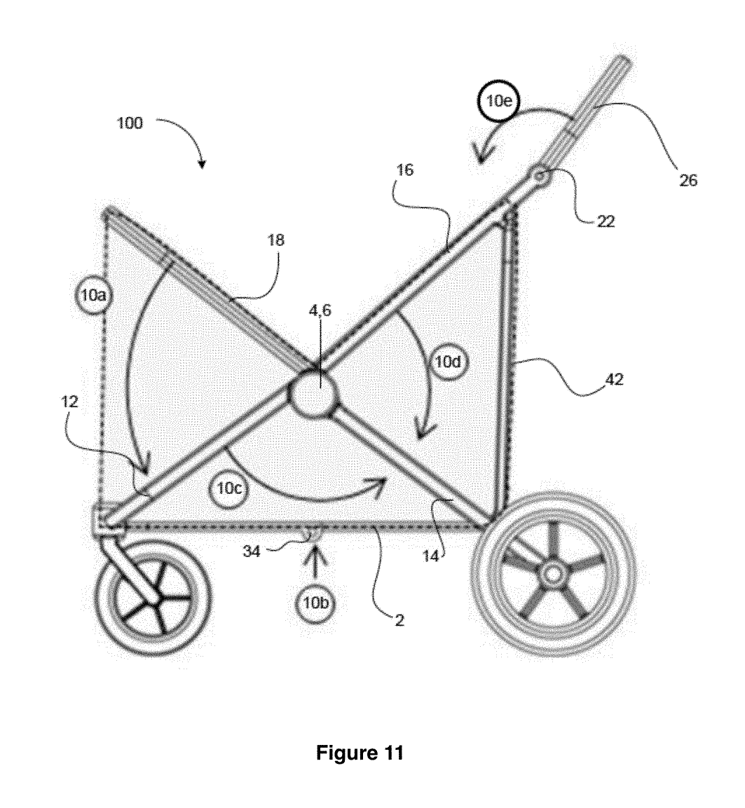

Upper rear support bar 16 contains minor right and left handle side-hinges 22, 24, which allow for selectively erecting a handle portion 26 by allowing handle portion 26 to pivot about hinges 22, 24 with respect to support bar 16 (i.e., swivel in the direction of arrows 10e in FIGS. 3, 11), to accommodate a comfortable positioning for the user in each configuration (deployed stroller or playpen, or folded), or allowing a further compacted position in the folded configuration. Additional or alternatively, hinges 22, 24 are operational for allowing the sliding of handle portion 26 in the direction of arrow 11e in FIG. 3, the thereby allow nesting of handle portion 26 in a compacted position in bar 16 and extending handle portion 26 in the un folded configurations. Handle portion 26 may further comprise a gripping sleeve, and may be interchangeable or retractable to meet the demands of a user. A seat support bridge 28 is proximate to minor right and left side-hinges 22, 24.

Seat lifting bar 42, an additional U-shape bar, is hinged at either rear corners 118, 120 of base support 2, or corners 106, 108 of lower rear support bar 14. A sheet 44 extends between seat lifting bar 42 and seat support bridge 28. Sheet 44 contains a cavity, hammock rest 46, wherein a child may rest, sit, crouch, recline, lie down etc. The term “hammock” in the context of rest 46 herein, was selected in mere reference to the folding qualities typifying hammock seats, and accordingly, hammock rest 46 is by no means confined to hammock-like shapes or resembling a hammock, e.g., rest 46 may be shaped as a foldable seat, “chair”, or bed. Accordingly, the term “seat” such as in the context of seat lifting bar 42 and seat support bridge 28, is not limited to seat-like rest 46 and refers to any rest. Seat lifting bar 42 may be in two different positions, a lowered, deployed position to allow for seating in the stroller configuration and a folded, raised position to allow for a playpen arrangement. Optionally, the lowered, deployed position of seat lifting bar 42, allows for an extended seat configuration adapted for lying of the child thereon.

FIG. 1A is a front view illustration of the convertible stroller 100 in an open stroller configuration. A safety harness 48 may be attached to hammock rest 46 including a buckle mechanism 50, allowing for safely securing a child. Safety harness 48 may be embodied in a form such as a safety belt, a three-point safety harness or a five point safety harness. In addition, hammock rest 46 may comprise a collapsible front gripping handle bar, usable by a child while seated in hammock rest 46 as well as to assist a child standing within a playpen configuration of convertible stroller 100. It is further noted, a hammock seat is used as an example embodiment of hammock rest 46 and an additional embodiment being a solid or rigid, folding seat.

A circumferential main curtain 52 spans between base support 2 and upper front support bar 16 and upper rear support bar 18. Main curtain 52 covers convertible stroller 100, both protecting the inside from external elements and confining anything within convertible stroller 100, thereby creating a safe playpen space for a child, as well as a “concealed” barrier in a concealed stroller configuration.

A pair of front wheels 54 and a pair of rear wheels 56 are located below base support 2. Front wheels 54 may connect to the front of base support 2 or to lower front support bar 12. Similarly, rear wheels 56 may connect to the rear section of base support 2 or to lower rear support bar 14. Each wheel may turn independently, coupled to at least one other wheel or not turn at all. Front and rear wheels 54, 56 may be embodied by traditional cylindrical wheels or ball casters. As depicted in FIG. 1A, front wheels 54 may be spaced apart from rear wheels 56 increasing stability and allowing a compact folded configuration. Front and rear wheels 54, 56 may also contain a locking mechanism for selectively preventing wheel roll and either of front or rear wheels 54, 56 may be removable allowing for a more adaptable convertible stroller 100 (e.g., being able to clean or replace a wheel).

Reference is now made to FIG. 2. FIG. 2 is an isometric illustration convertible stroller 100 in a playpen with side access configuration. The rotation of upper front support bar 18 in a clockwise motion about right and left joint side-hinges 4, 6 and raising seat lifting bar 42 into a folded upright state, transitions convertible stroller 100 from traditional, open stroller configuration, to a playpen with side access configuration (also functional as a concealed-stroller configuration). Latch 60 may allow for a selective locking of upper front support bar 18, allowing for easy rotation between configurations as well as secure stabilization in each configuration. As seen in FIG. 2, two left and right open gaps 62, 64 may be present in the open playpen configuration, allowing for access to within the playpen from the sides.

In reference to FIG. 3, there is shown an isometric illustration of the stroller 100 in a full playpen configuration. Left and right open gaps 62, 64 are covered by erecting or attaching two right and left complimentary curtains 66, 68 forming a ‘full’ playpen configuration. Right and left complimentary curtains 66, 68 may be erected by a zipper, a set of corresponding fastening strips, e.g., Velcro® strips or any hook and loop fasteners, a pair of magnets, an interlocking buckle or a string 70, and similarly main curtain 52 may be removably attachable with similar means. When not in erected position, right and left complimentary curtains 66, 68 may be attached to upper front and rear support bar 16, 18. In a full playpen configuration, access to the inside of convertible stroller 100 is solely from above.

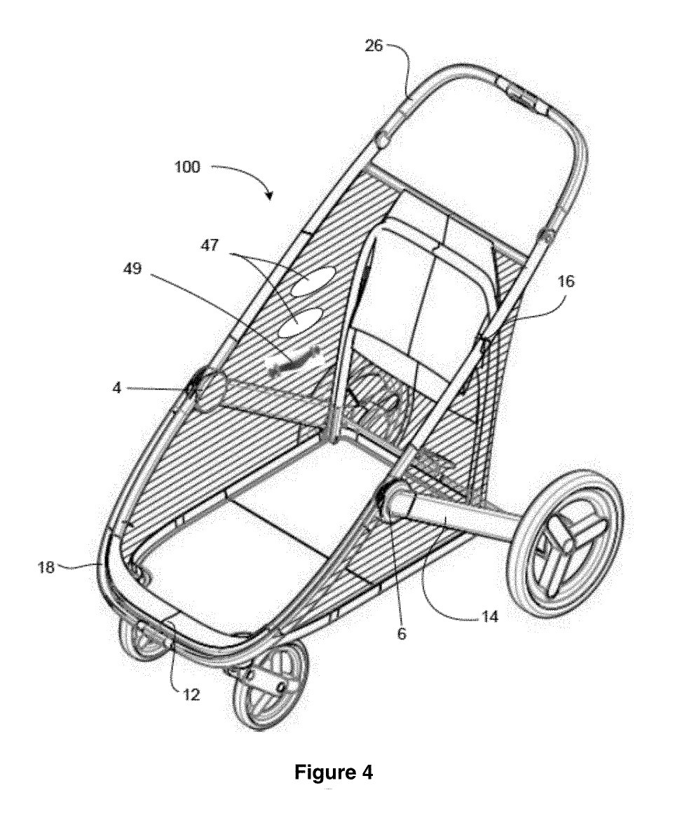

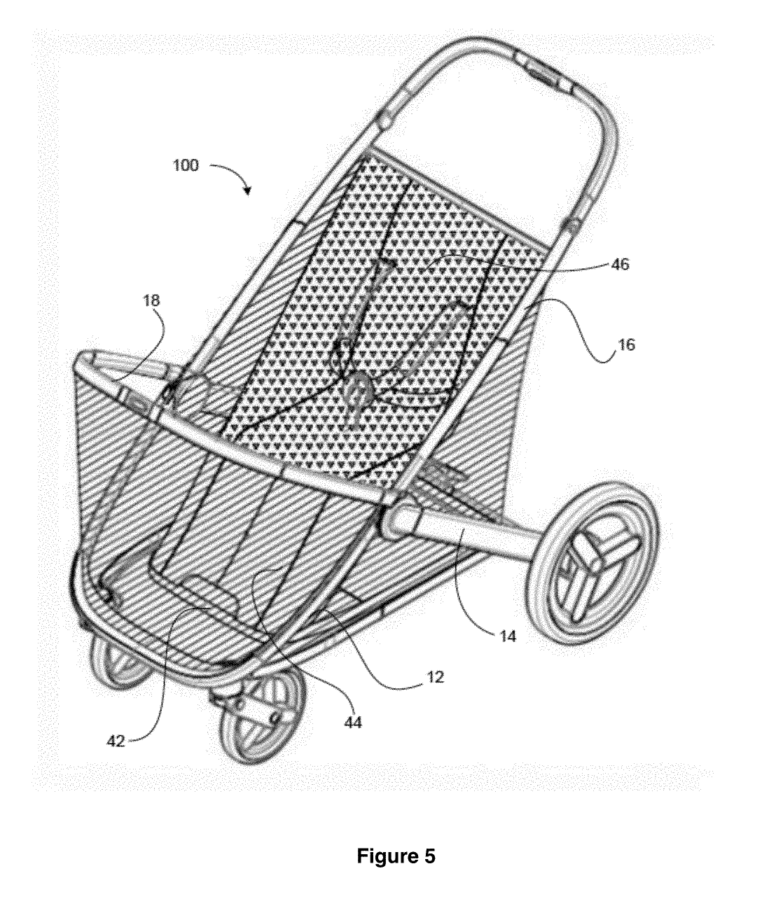

FIGS. 4 and 5 illustrate two possible hybrid configurations of convertible stroller 100. FIG. 4 is an isometric illustration of stroller 100 in an open playpen configuration. FIG. 5 is an isometric illustration of stroller 100 in an enclosed stroller configuration. FIG. 4 depicts an open playpen, wherein seat lifting bar 42 is raised, collapsing hammock rest 46, and upper lower support bar 18 is at a lowered position. This allows for full access with the seat still stowed in a collapsed position. FIG. 5 depicts an enclosed stroller configuration of convertible stroller 100, with a full encapsulation of base support 2 including seat lifting bar 42 at a lower position, allowing for the full use of hammock rest 46, while upper front support bar 18 is in a raised position (concealed stroller configuration).

Optional child climbing and gripping means may be disposed on main curtain 52. As exemplified in FIG. 4, apertures 47 and protruding strap 49 may facilitate a child of suitable age to climb over main curtain 52 or provide a playing object. Apertures 47 may be covered by a removable cover to prevent climbing when unsafe for a young child.

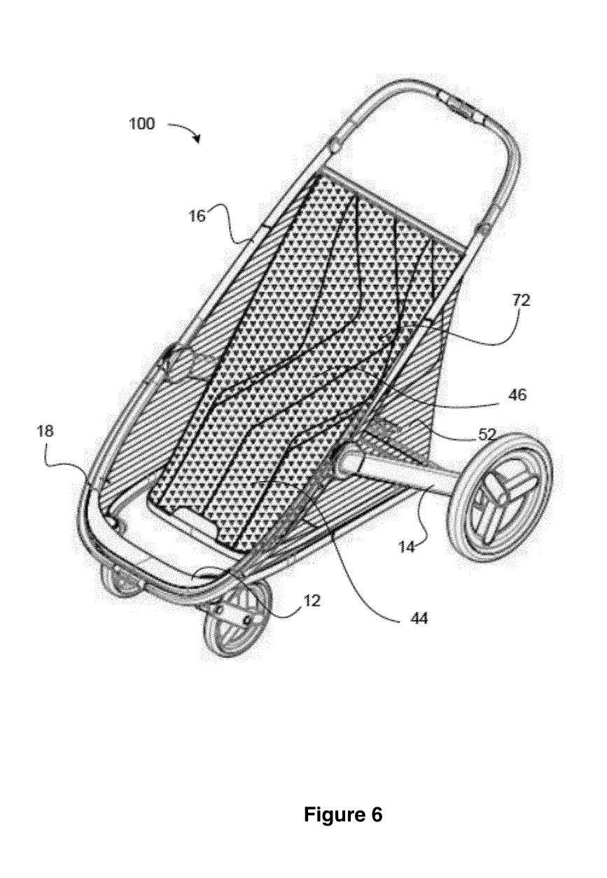

FIG. 6 is an isometric illustration of the stroller 100 in an open stroller configuration with an extended flat seat configuration of hammock rest 46 adapted for laying position. In relation to FIG. 1, wherein at seat bight 72 of hammock rest 46, sheet 44 rises at a slight vertical incline to seat support bridge 28. However, in FIG. 6, the location of seat bight 72 extends in a further rear direction towards main curtain 52, creating a longer flat section of sheet 44, suitable for lying down of a child. A lying down requirement may be similarly accomplished on covering material 32 while configured to any playpen configuration. In addition to this possible alteration, hammock seat 26 may be altogether removable from convertible stroller 100. A double seat or an additional seat may also be used in conjunction to hammock rest 46 or as opposed to hammock rest 46. A generic baby seat, such as a bassinet or a safety seat may be coupled to covering material 32, to hammock rest 46 or to upper front and rear support bars 16, 18. This may allow for more diverse functionality of convertible stroller 100. For example, coupling a car seat to convertible stroller 100 may be used for a seamless transition from a mobile, stroller configuration of convertible stroller 100 to a secure embodiment within a car, all with the same seat.

Regardless of the configuration, or if there is a child present, convertible stroller 100 may have additional space on base support 2 for allowing convenient transportation of other items. There may be an additional embodiment that allows for rear access or below a deployed hammock rest 46. This access may be selectively opened with a securable agent such as zipper or fastening strip. As mentioned, even without a rear access embodiment, convertible stroller 100 may still be used in a similar capacity to a shopping cart commonly used at a supermarket.

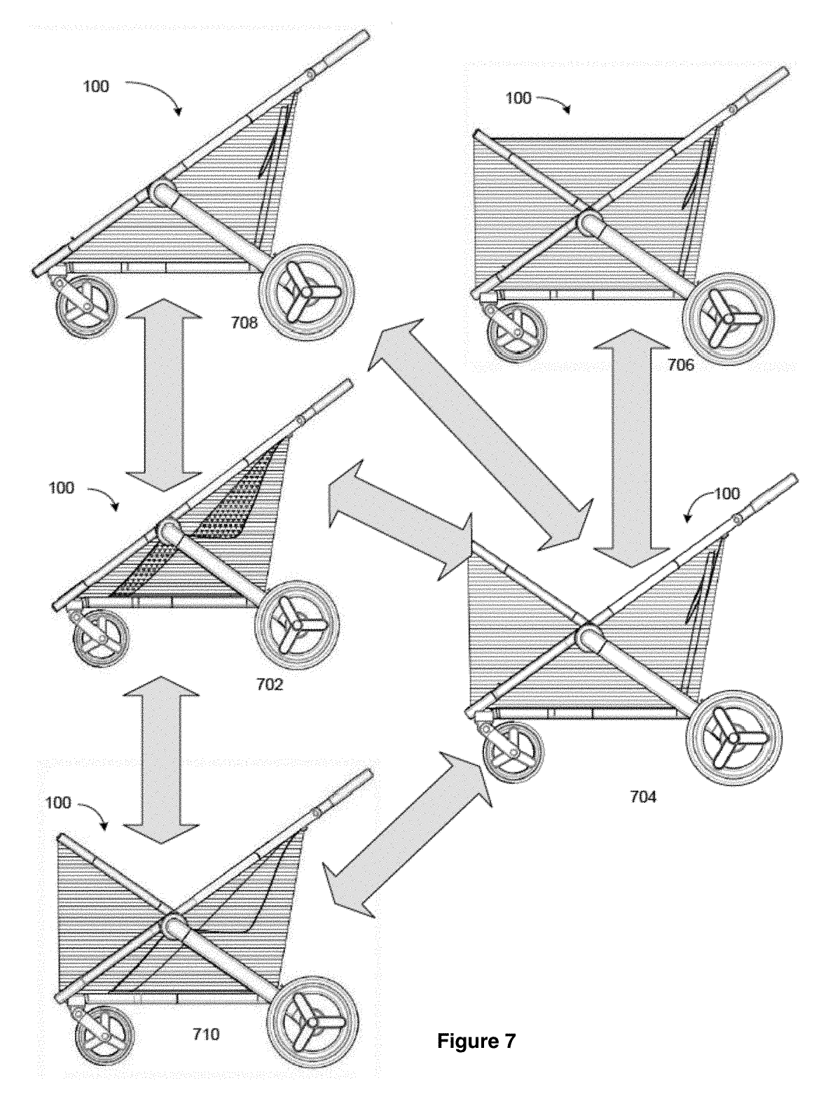

Reference is now made to FIG. 7. FIG. 7 is a series of side view illustrations of various configurations of the stroller 100 demonstrating the ease of reconfiguration. From an open stroller configuration 702, upper front support bar 18 and seat lifting bar 42 are at lowered positions. Rotating upper front support bar 18 upwards around left and right joint side-hinge units 4, 6, forms a full encapsulation. Lifting seat lifting bar 42, folding of hammock rest 46 defines a playpen with side access configuration 704. From configuration 704, optional, complimentary side curtains 66, 68 may be erected to form a fully erect playpen configuration 706. From an open stroller configuration 702, seat lifting bar 46 may be raised, collapsing hammock rest 46 into an open playpen configuration 708. Configuration 708 may additionally be configured from a playpen with side access configuration 704 by rotating upper front supper bar 18 down around right and left joint side-hinge units 4, 6. Additionally, from open stroller configuration 702, upper front support bar 18 may be rotated upwards around right and left joint side-hinge units 4, 6 to form an enclosed (concealed) stroller configuration 710. Enclosed (concealed) stroller configuration may be alternatively configured from a playpen with side access configuration 704 by lowering seat lifting bar 42 hence deploying hammock rest 46.

As noted by FIG. 7, each of these configurations is reversible allowing for an intuitive, flexible convertible stroller design. It is further noted, that while these are the major configurations of convertible stroller 100, there may be additional configurations possibly requiring slight modifications to stroller 100, which are not illustrated in FIG. 7. The configurations in FIG. 7 are merely meant to serve as an example of the method and ease of converting convertible stroller 100 between configurations.

The nomenclature for convertible stroller 100 has been derived in relation to a combination of the position of seat lifting bar 42 and the position of upper support bar 18. When, for example, seat lifting bar 42 is at a lower position, a deployed hammock rest 46 is available, defining a stroller configuration, and a raised seat lifting bar 42, collapsing hammock rest 46, defines a playpen configuration. The nomenclature used continues from the amount of access provided. Such as, the relative raised or lowered position of upper front support bar 18 allowing for an open, full access configuration or an enclosed, limiting access configuration. This nomenclature used is purely used as an example for consistency of this description and naming for different configurations may vary in different embodiments.

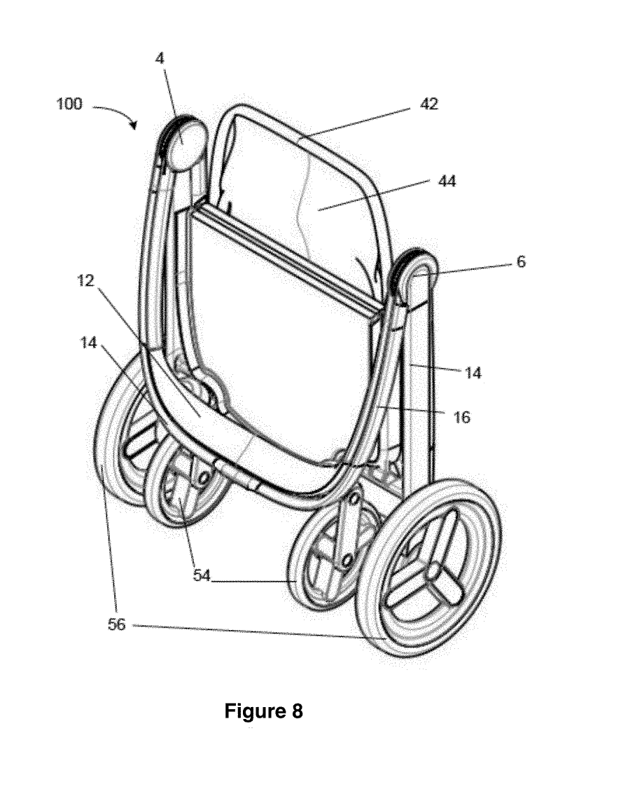

In reference to FIG. 8, there is shown an isometric illustration of stroller 100 in a folded configuration. As illustrated, support bars 12, 14, 16, and 18 are located in a common orientation around right and left side joint hinges 4, 6 and thereby are substantially nested within each other to assume little space. Further folding of intermediate base hinge 34 to collapse base support 2 (collapsing base support 2 is also possible without hinge 34, such as by flexible support 2), folding upper rear support bar 16 over minor left and right side handle hinges 22, 24, and an optional collapsing of handle portion 26, finalizes a folded configuration. The folded configuration may be used for portability, including an optional handle, configured to be coupled or included on seat lifting bar 42. In addition, a bag may be attached to convertible stroller 100 which may be used to store objects or as a cover for stroller 100 when in a folded configuration.

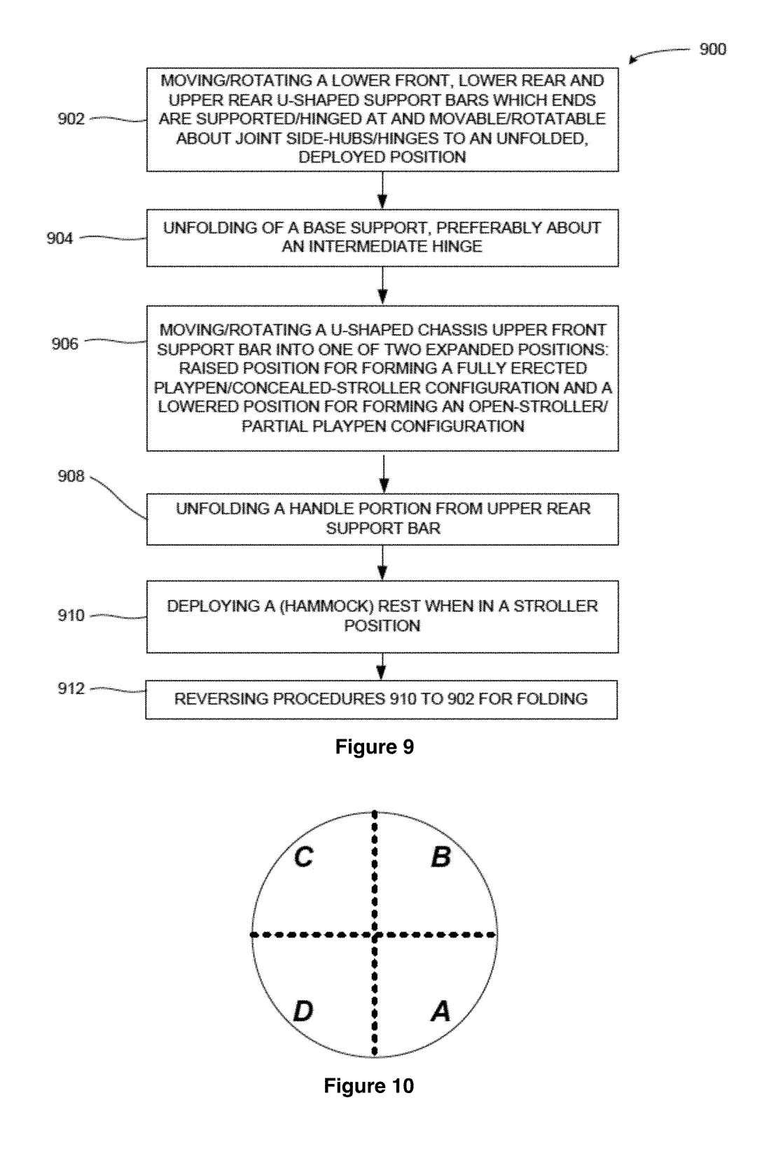

Reference is now made to FIGS. 9 and 10. FIG. 9 is a flow chart of a method 900 for converting a convertible stroller for children, between stroller, playpen and folded configurations, operative in accordance with an embodiment of the present invention. FIG. 10 is a side view illustration of a joint hinges of the stroller structure of FIG. 1, divided by quadrants for locking hinged support bars, referencing a simplified, exemplary cross sectional representation, of left and right joint side-hinges 4, 6. Although FIGS. 9 and 10 reference the stroller structure of FIG. 1, their teaching are applicable, mutatis mutandis, to the stroller, structures 200, 300, and 400 of FIGS. 14A to 16E. This cross-sectional representation is shown as a circle with four regions, defining a lower rear section, “A,” and an upper rear section, “B,” representing the domain around the left and right joint side-hinges 4,6 for potential orientations of support bars 12, 14, 16 and 18. The front regions continue following this notation, “C” referring to the upper front region appropriate only for upper front support arm 18 and “D” referring to the lower front region possible for both upper and lower front support arm 16, 18. In FIG. 9, stroller 100, initially being in a folded configuration, wherein each support bar is in the same quadrant, which will be designated as “A”, as also seen in FIG. 8. First, in procedure 902, lower front, lower rear and upper rear U-shaped chassis support bars, which ends are hinged at, and rotatable about, a pair of right and left joint side-hinges, are rotated to an unfolded, deployed position when fully (or partially for an open stroller configuration) expanded about the joint side-hinges for rendering the convertible stroller in an unfolded configuration. Lower front, lower rear and upper rear U-shaped chassis support bars, which ends are supported at and movable about a pair of right and left joint side-hubs, are moved to an unfolded, deployed position when fully (or partially for an open stroller configuration) expanded about the joint side hubs for rendering the convertible stroller in an unfolded configuration. In reference to FIGS. 1-6 and 8, lower front, lower rear and upper rear U-shaped chassis support bars, 12, 14, and 16, respectively, whose open side ends are hinged at and rotatable about a pair of right and left joint side-hinges 4, 6. In reference to FIGS. 14a to 16E, lower front, lower rear and upper rear U-shaped chassis support bars, 212/312/412, 214/314/414, and 216/316/416, respectively, whose open side ends are hinged at and rotatable about a pair of right and left joint side-hubs 204/304/404, 206/306/406.

Next, in procedure 904, a base support is unfolded, preferably about an intermediate hinge. In reference to FIGS. 1 to 6 and 8, base support 2 is unfolded about an optional intermediate hinge 34.

Further, in procedure 906, a U-shaped chassis upper front support bar is moved or rotated into one of two expanded positions: raised position—for forming a fully erected playpen configuration or a concealed-stroller configuration, and lowered position—for forming an open-stroller configuration (which in some cases can also serve for a partial playpen configuration). In reference to FIGS. 1 to 6 and 8, U-shaped chassis upper front support bar 18 is rotated into one of two expanded positions: raised position for forming a fully erected playpen configuration or a concealed-stroller configuration, and lowered position for forming a partial playpen configuration or an open-stroller configuration. In reference to FIGS. 14A to 16E, U-shaped chassis upper front support bar 218, or bars 318A and 318B, or bar 418 is rotated or moved into one of two expanded positions: raised position for forming a fully erected playpen configuration or a concealed-stroller configuration, and lowered position for forming a partial playpen configuration or an open-stroller configuration. In procedure 908, which is an optional procedure, a handle portion, hinged to, or nested in, the upper rear support bar, is unfolded from or with respect to the upper rear support bar, for allowing pushing and pulling of the stroller. In reference to FIGS. 1 to 6 and 8, handle portion 26 is hinged to, or nested in, upper rear support bar 16 at minor handle hinges 22, 24.

In procedure 910, which is an optional procedure, a rest, such as a hammock seat, is deployed when the convertible stroller is in a stroller configuration. Preferably a U-shaped seat lifting bar, hinged at the ends of the seat lifting bar is lowered for allowing sitting of the child in the rest in a stroller configuration. In reference to FIGS. 1 to 6 and 8, hammock rest 46 is deployed when convertible stroller 100 is in a stroller configuration, and U-shaped seat lifting bar 42, hinged at the ends thereof can be lowered to assume a sitting configuration.

In procedure 912, procedures 910 to 902 are reversed for folding the convertible stroller.

Reference is now made to FIG. 11, which is a side view illustration of stroller 100 demonstrating a conversion from a full playpen configuration to a folded configuration, demonstrating procedure 912 of method 900, i.e., the reversing of procedures 910 to 902. First, rotation along arrow 10a of upper front support bar 18 downward around left and right joint side-hinges 4, 6 (not necessary if bar 18 is already lowered for the open stroller configuration or the partial playpen configuration. Then, intermediate hinge 34 is folded in direction 10b to allow folding and collapsing of base support 2. Next, both upper and lower front support bars 12, 18 are rotated along arrow 10c around left and right joint side-hinges 4, 6 to a lower position. Following this, upper rear support bar 16 is rotated along arrow 10d around right and left joint side-hinges 4, 6, lowering all support bars to be in the same quadrant for a folded configuration (as in FIG. 8). Finally, handle portion 26 is folded along arrow 10e (seen also in FIG. 3) and/or arrow 11e (FIG. 3 only) over left and right minor handle hinges 22, 24 for providing a fully folded configuration of convertible stroller 100.

As a common problem may be the limited ability to move convertible stroller 100, an embodiment may exist wherein some of all of the movement of convertible stroller 100 is motorized by an onboard, drive and control unit, which may be controlled by an onboard interface or via wireless or mobile communication interface. In addition, a global positioning system (GPS) tracker may be embedded to allow for the locating of convertible stroller 100 by the owner.

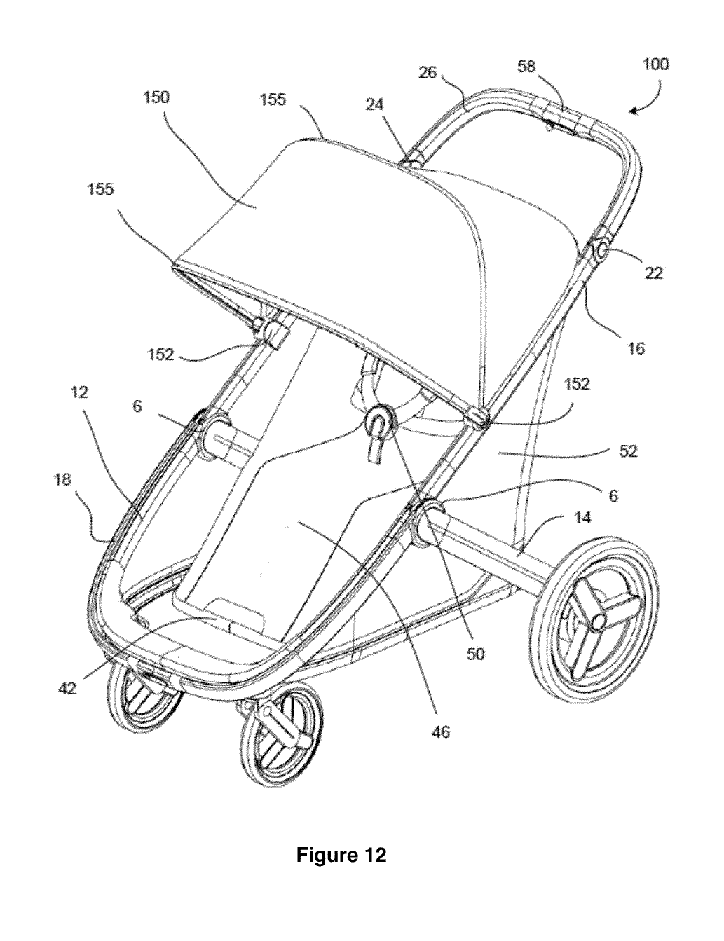

Reference is now made to FIG. 12 which is an isometric illustration of the stroller structure 100 of FIG. 1 featuring a canopy 150, operative as a sunshade hood and as a rain protective awning. Canopy 150 is detachably fastened to stroller 100 by fasteners 152 which hold onto rear upper bar 16. Fasteners 152 also allow pivoting of frame 155 for collapsing canopy 150 into a folded configuration adjacent bar 16, allowing the folding of stroller 100 as described above.

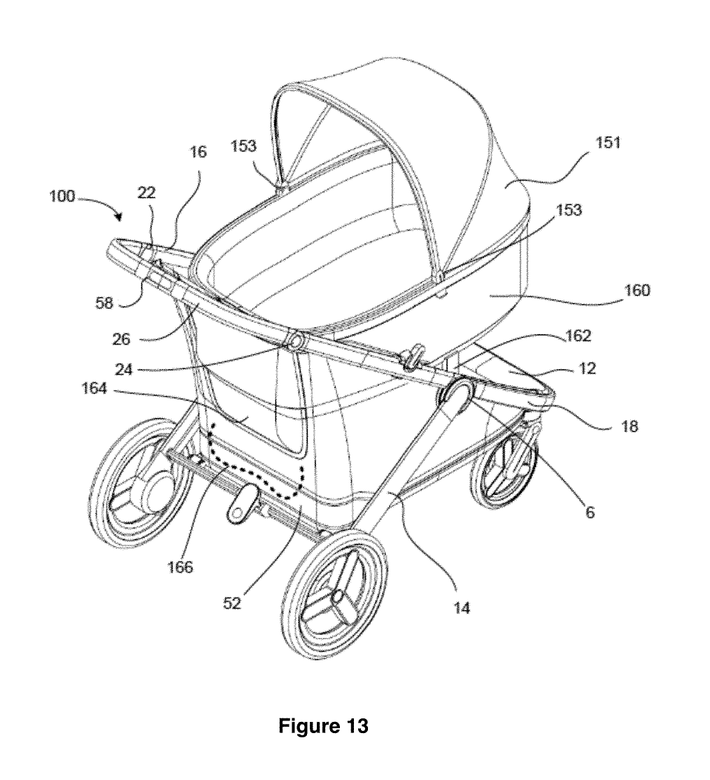

In reference to FIG. 13, there is shown an isometric illustration of the stroller structure 100 of FIG. 1 featuring a bassinet 160. Bassinet 160 (or other cradle or carrycot) is detachably fastened to stroller 100 by fasteners which hold onto rear upper bar 16, or to joint side hinges 6, by suitable connectors, such as connectors 162. Upper front support bar 18, is usually lowered as in the open stroller configuration for making room to bassinet 160. Canopy 151, which may be similar in structure and operation to canopy 150 (appropriately designed, the same canopy may also apply for both positions), is attached, permanently or detachably, to bassinet 160 by fasteners 153, and may be analogously foldably collapsible about fasteners 153. In this configuration, before folding stroller 100, Bassinet 160 is removed.

FIG. 13 also illustrates further features which are not confined to the context of a bassinet. Main curtain 52 (which may be removed when bassinet 160 is deployed) preferably features a closable rear access aperture in main curtain 52 for conveniently accessing base bottom 32 (e.g., for placement and removal of objects). Aperture 166 may be cut in main curtain 52, as is shown by perforated line 166, and may be selectively closed by means such as a zipper, fastening strips, and buttons and loops. Stroller 100 may also feature a rear bag, such as bag 164, which is hanging on bar 16 or combined with the rear portion of curtain 52 (preferably above rear aperture 166 for leaving aperture 166 accessible). Bag 164 does not hamper the folding and unfolding of stroller 100 while remaining attached thereto.

Reference is now made to FIGS. 14A to 16E, which demonstrate examples of hinges which are not joint, which are dispersed in central side-hubs or cores, and of connection structures other than hinges for connecting the U-shaped bars to the side-hubs of the stroller. FIGS. 14A to 16E resemble the embodiment of FIG. 1 and therefore the description below focuses on the modifications while description of similar parts is not reiterated.

Reference is now made to FIGS. 14A, 14B, 14C, and 14D which illustrate another embodiment of a convertible stroller, denoted 200, constructed and operative in accordance with the invention. FIG. 14A is a side view illustration of stroller 200 in an open stroller configuration; FIG. 14B is an isometric illustration of stroller 200 in an open stroller configuration; FIG. 14C is a side view illustration of stroller 200 in a playpen configuration; and FIG. 14D is an isometric illustration of stroller 200 in a playpen configuration. Convertible stroller 200 is similar to stroller 100, which is modified by a displaced hinging of the upper front U-shaped bar. Convertible stroller 200 includes a base support 202 which is similar to support 2 of stroller 100, and four U-shape chassis support bars: lower front support bar 212, lower rear support bar 214, upper rear support bar 216, and upper front support bar 218. Bars 212, 214, and 216 are radially oriented around and hinged at a pair of central left and right joint side-hinge units 204 and 206, respectively, and analogously function as corresponding bars 12, 14, and 16, and hinges 4 and 6 of stroller 100. Upper Front U-shaped bar 218 is hinged at a pair of displaced left and right side-hinges 205 and 207, which are displaced with regard to hinges 204 and 206 along the side arms of bar 212. Hinges 205 and 207 enable bar 218 to be selectively rotated into: (1) a fully expanded, raise deployed position, to render the stroller in a concealed-stroller configuration or in a full playpen configuration, as is shown in FIGS. 14C and 14D; and a partially expanded, lowered deployed position, while neighboring base 202, to render the stroller in a partial playpen configuration or in an open-stroller configuration, as is shown in FIGS. 14A and 14B. The rotation of bar 218 is performed with respect to bar 212, and accordingly its partially expanded position and its folded position are dependent on the positioning of bar 212, i.e., folded to essentially overlap, brace, or be adjacent to bar 212 (in both partially expanded and folded positions of bar 218), while the partial expansion of bar 218 as of FIGS. 14A and 14B is performed once bar 212 is rotated into a fully deployed position. Hinge 204 (206 on the other side), and 205 (207 on the other side) of stroller 200, are disposed in a central core side-hub denoted by perforated line 209 (211 on the other side) which functions as a side-hub where all the side hinges 204 and 205 (206 and 207 on the other side) are distributed, and thereby allowing hubs 209 and 211 and hinges 204, 205, 206, and 207 to function similar to hinges 4 and 6 of stroller 100.

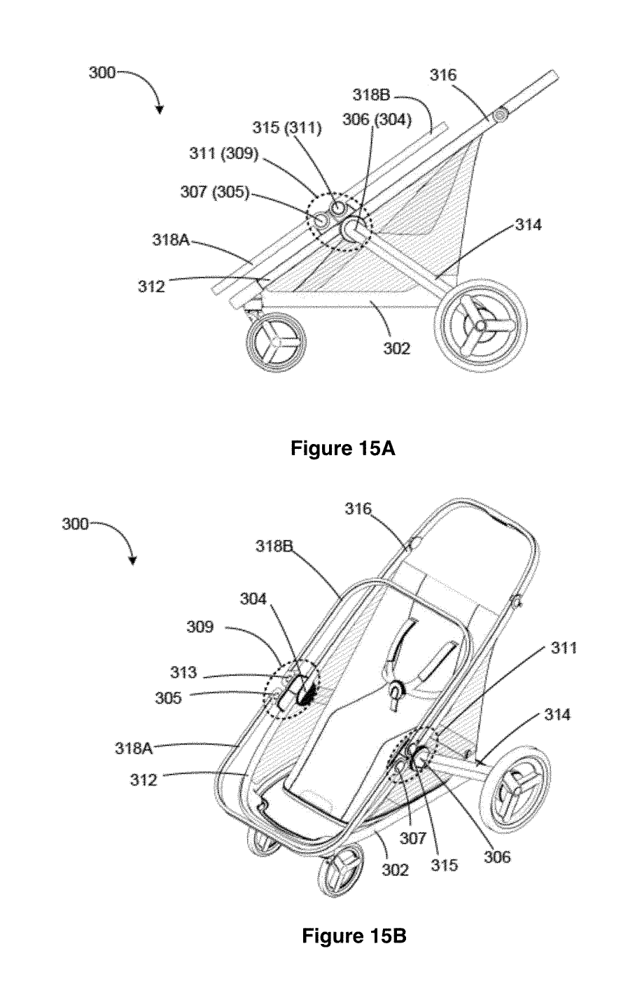

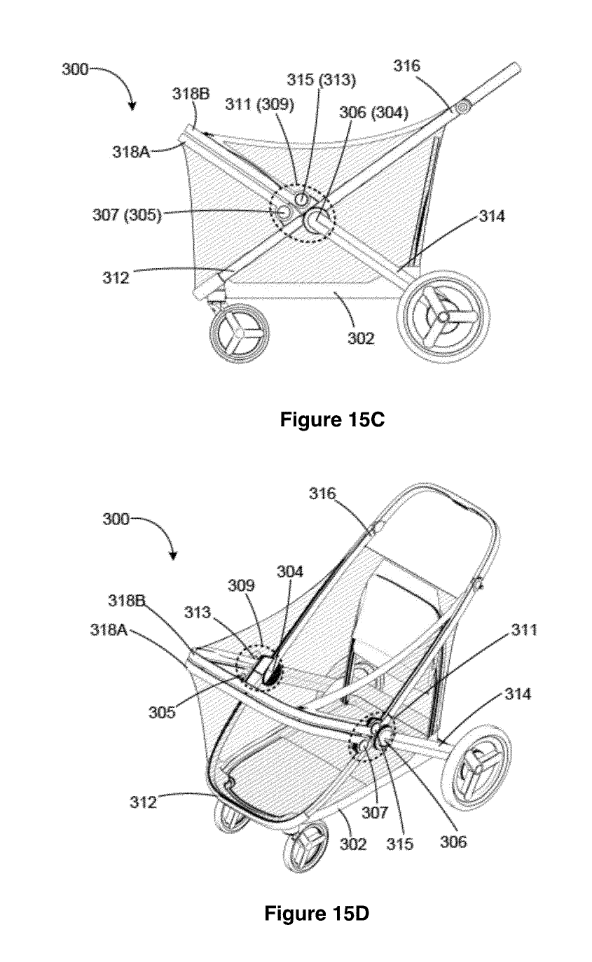

Reference is now made to Figures to FIGS. 15A, 15B, 15C, and 15D which illustrate a further embodiment of a convertible stroller, denoted 300, constructed and operative in accordance with the invention. FIG. 15A is a side view illustration of stroller 300 in an open stroller configuration; FIG. 15B is an isometric illustration of stroller 300 in an open stroller configuration; FIG. 15C is a side view illustration of stroller 300 in a playpen configuration; and FIG. 15D is an isometric illustration of stroller 300 in a playpen configuration. Convertible stroller 300 is similar to strollers 200 (and as such also to stroller 100), which is modified by splitting the upper front support bar into two upper front U-shaped bars, whose hinges are displaced along the lower front and the upper rear U-shaped bars. Convertible stroller 300 includes a base support 302 which is similar to supports 2 and 202 of strollers 100 and 200, and five U-shape chassis support bars: lower front support bar 312, lower rear support bar 314, upper rear support bar 316, a first upper front support bar 318A and a second upper front support bar 318B. Bars 312, 314, and 316 are radially oriented around and hinged at a pair of central left and right joint side-hinge units 304 and 306, respectively, and analogously function as corresponding bars 212 (or 12), 214 (or 14), 216 (or 16) and hinges 204 (or 4) and 206 (or 6) of stroller 200 (or 100). First upper front U-shaped bar 318A is hinged at a pair of displaced left and right side-hinges 305 and 307, which are displaced with regard to hinges 304 and 306 along the side arms of bar 312. Second upper front U-shaped bar 318B is hinged at a pair of displaced left and right side-hinges 313 and 315, which are displaced with regard to hinges 304 and 306 along the side arms of bar 316. Hinges 305, 307, 313, and 315 enable bars 318A and 318B to be selectively rotated into: (1) a fully expanded, raise deployed position, to render the stroller in a concealed-stroller configuration or in a full playpen configuration, as is shown in FIGS. 15C and 15D; and a partially expanded, lowered deployed position, while bar 318A neighbors base 302, to render the stroller in a partial playpen configuration or in an open-stroller configuration, as is shown in FIGS. 15A and 15B. The rotation of bars 318A and 318B is performed with respect to bar 312 and 316, respectively, and accordingly their partially expanded position and folded position are dependent on the positioning of bars 312 and 316, i.e., folded to essentially overlap, brace, or be adjacent to bar 312 and 316 correspondingly (in both partially expanded and folded positions of bars 318A, 318B), while the partial expansion of bar 318 as of FIGS. 15A and 15B is performed once bars 312 and 316 are rotated into their fully deployed position. Hinge 304 (306 on the other side), 305 (307 on the other side), and 313 (315 on the other side) of stroller 300, are disposed in a central core side-hub denoted by perforated line 309 (311 on the other side) which functions as a side-hub where all the side hinges 304, 305, and 313 (306, 307, and 315 on the other side) are distributed, and thereby allowing hubs 309 and 311 and hinges 304, 305, 306, 307, 313, and 315 to function similar to hinges 4 and 6 of stroller 100, or hubs 209 and 211 of stroller 200. In a further modification of stroller 300, bar 318A may be omitted, leaving bar 318B as the single upper front support bar. It is noted that the displaced hinging of either bar 318A or bar 318B, or with further displaced hinges, may be applied for displaced hinging of either bar 312 or 316, in an alternative or a multi-hinged arrangement of a side-hub.

According to another embodiment of the invention, the open ends of the upper rear support bar, the lower front support bar, and the lower rear support bar, are hinged at and rotatable about the joint side-hubs, and foldably collapsible about the joint side hubs into a nested arrangement when the stroller in the folded configuration, and are rotatably expandable about the joint side hubs into a fully deployed position when the stroller is in the stroller configuration or the playpen configuration. The upper front support bar is telescopically expandable from the lower rear support bar into a raised deployed position when fully expanded to render the stroller in a playpen configuration, and is telescopically collapsible with the lower rear support bar into a nested arrangement when the stroller is in the folded configuration, or an open-stroller configuration.

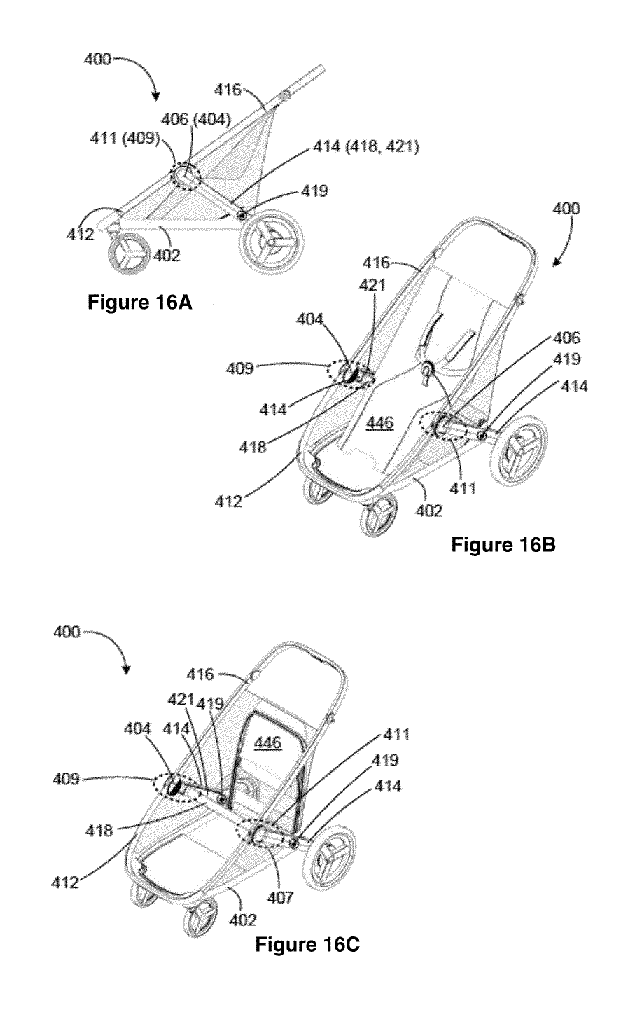

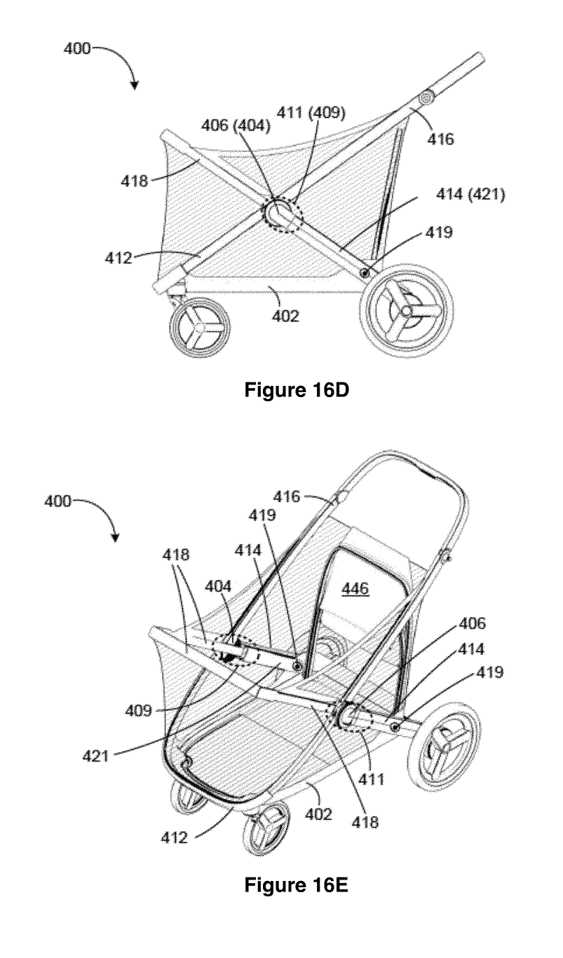

Reference is now made to Figures to FIGS. 16A, 16B, 16C, 16D, and 16E which illustrate a further embodiment of a convertible stroller, denoted 400, constructed and operative in accordance with the invention. FIG. 16A is a side view illustration of stroller 400 in an open stroller configuration; FIG. 16B is an isometric illustration of stroller 400 in an open stroller configuration; FIG. 16C is an isometric illustration of stroller 400 in an open stroller configuration with its seat folded for allowing conversion into playpen configuration; FIG. 16D is a side view illustration of stroller 400 in a playpen configuration; and FIG. 16E is an isometric illustration of stroller 400 in a playpen configuration.

Convertible stroller 400 is similar to strollers 100, 200, and 300, which are modified by featuring a telescopically collapsible upper front support bar which is linearly extendable from the lower rear support bar. Convertible stroller 400 includes a base support 402 which is similar to supports 2, 202, and 302, and four U-shape chassis support bars: lower front support bar 412, lower rear support bar 414, upper rear support bar 416, and upper front support bar 418. Bars 412, 414, and 416 are radially oriented around and hinged at a pair of central left and right joint side-hinge units 404 and 406, respectively, and analogously function as corresponding bars 12/212/312, 14/214/314, 16/216/316 and corresponding hinges 4/204/304 and 6/206/306 of strollers 100/200/300. Accordingly, the open ends of upper rear support bar 416, lower front support bar 412, and lower rear support bar 414, are hinged at and rotatable about the joint side-hinges 404 and 406, and foldably collapsible about joint side hinges 404 and 406 into a nested arrangement when stroller 40 is in the folded configuration, and are rotatably expandable about joint side hubs 409, 411 (cores containing hinges 404, 406) into a fully deployed position when stroller 400 is in the stroller configuration (FIGS. 16A and 16B) or the playpen configuration (FIGS. 16D and 16E).

Upper front U-shaped bar 418 is telescopically nested between the side arms of lower rear support bar 416, with its open side inverted respective to the open side of bar 414, and is collapsible by virtue of being retractably extendable from bar 416. The term “telescopic” refers to the disposition of bar 418 within bar 414, with its side arms adjacently braced by parallel arms of bar 414, the linear sliding outward or inward with its side arms maintained in parallel to the bracing side arms of bar 414, and any coupling means such as guiding slits or rails may be applied. In a somewhat modified embodiments bar 418 may be the outer bracing element wherein inverted U-shaped bar 414 is nested within bar 418, to thereby analogously feature a telescopic arrangement. The side arms of bar 418 emerge through paths crossing hinges 404 and 406 (or side cores or hubs 409, 411 in which hinges 404 and 406 are disposed), rendering side hubs 409 and 41 into elements to which all the four bars 412, 414, 416, and 418 are connected, and about which are movable to assume their retracted or expanded positions. Accordingly, upper front support bar 418 is telescopically expandable from lower rear support bar 414 into a raised deployed position when fully expanded to render the playpen configuration (FIGS. 16D and 16E) and is telescopically collapsible with lower rear support bar 414 into a nested arrangement when the stroller is in the folded configuration, or the stroller configuration (FIGS. 16A, 16B, and 16C). Seat 446 is designed to deploy for resting a child above bar 418, when bar 418 is nested in its lowered position for a stroller configuration (bar 418 can be then utilized to provide a further support to seat 446), and to fold as in the interim constellation shown in FIG. 16C before its deployment for resting a child or before conversion of stroller 400 to a folded configuration or a playpen configuration.

It is noted that FIGS. 16A and 16B exemplify the open stroller configuration. If a concealed stroller configuration is desired, bar 418 may be modified for example by splitting into two telescopically extendable U-shaped bars, featuring an internal bar nested within an external bar, such that when the external bar is raised as in FIGS. 16D and 16E, while the internal bar remains in the lower position as in FIGS. 16A, 16B, and 16c, the retracted internal bar may support seat 446 for the stroller configuration while the raised external bar provides the frame for holding the concealing curtain in the front as in FIGS. 16D and 16E. In such a constellation, both the internal and external bars of bar 418 are raised to assume the position of a single bar 418 shown in FIGS. 16D and 16E.

If a partial playpen configuration is desired, bar 418 may be modified for example by allowing its pivoting about hinges 419 disposed further down along the arms of bar 414, in proximity to deployed base 402, and thus tilting to stand by the rear wall of the curtain near the folded seat 446 or to lay on base 402. Such an arrangement may be provided for example by pivotal rails 421 which are detachably mounted to the side arms of bar 414, and which guide the side arms of bar 418. Rails 421 are hinged at hinges 419 to the side arms of bar 414 proximate to base 402 (when deployed) and are detachably affixed (e.g., by a suitable locking mechanism) to the side arms of bar 414 for limiting bar 418 to a linear movement contiguous to the arms of bar 414 when stroller 400 is in a folded configuration, stroller configuration, and full playpen configuration, wherein the pivoting is reserved for the partial playpen configuration.

Accordingly, bar 418 can be selectively moved into: (1) a fully expanded, raise deployed position, to render stroller 400 in a concealed-stroller configuration or in a full playpen configuration, as is shown in FIGS. 16C and 16D, or a partially expanded, lowered deployed position, wherein the lower ends of its arms neighbor base 402, to render the stroller in a partial playpen configuration or in an open-stroller configuration, as is shown in FIGS. 16A and 16B.

According to another modified embodiment (not shown) of a stroller such as stroller 100, the open ends of an upper front support bar (e.g., 18), a lower front support bar (e.g., 12), and lower rear support bar (e.g., 14), are hinged at and rotatable about the joint side-hubs (e.g., hinges 4 and 6), and foldably collapsible about the joint side hubs into a nested arrangement when the stroller is in the folded configuration, and rotatably expandable about the joint side hubs into a fully deployed position when the stroller is in the stroller configuration or the playpen configuration. The modification is featured with an upper rear support bar which is telescopically expandable from the lower front support bar into a raised deployed position when fully expanded to render the stroller in a stroller configuration or in a playpen configuration, and is telescopically collapsible to the lower front support bar into a nested arrangement when the stroller is in the folded configuration.

According to a further modified embodiment (not shown) of a stroller such as stroller 100, the open ends of the lower front support bar and the lower rear support bar, are hinged at and rotatable about the joint side-hubs, and foldably collapsible about the joint side hubs into a nested arrangement when the stroller in the folded configuration, and are rotatably expandable about the joint side hubs into a fully deployed position when the stroller is in the stroller configuration or the playpen configuration. The modification is featured with an upper front support bar which is telescopically expandable from the lower rear support bar into a raised deployed position when fully expanded to render the stroller in a concealed-stroller configuration or in a full playpen configuration, and is telescopically collapsible to the lower rear support bar into a nested arrangement when the stroller in the folded configuration, an open-stroller configuration, or in a partial playpen configuration. An upper rear support bar is telescopically expandable from the lower front support bar into a raised deployed position when fully expanded to render the stroller in the stroller configuration or in the playpen configuration, and is telescopically collapsible to the lower front support bar into a nested arrangement when the stroller in the folded configuration.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. A foldable convertible stroller for children, converting between various stroller, playpen, and folded configurations, the convertible stroller comprising:
U-shaped chassis support bars comprising an upper front support bar, an upper rear support bar, a lower front support bar, and a lower rear support bar, the open ends of said U-shaped bars connected at and movable about joint side-hubs, and foldably collapsible about said joint side hubs into a nested arrangement when the stroller is in the folded configuration, and;
a base support coupled to said lower front support bar and lower rear support bar, enclosing a covering material and folded when the stroller is in the folded configuration, wherein:
said upper rear support bar, lower front support bar and lower rear support bar are expandable about said joint side hubs into a fully deployed position when the stroller is in the stroller configuration or the playpen configuration;
when the stroller is in the stroller configuration or the playpen configuration, said upper front support bar is selectively expandable about said joint side hubs into:
a raised deployed position when fully expanded to render the stroller in a concealed-stroller configuration or in a full playpen configuration; and/or
a lowered position to render the stroller in an open-stroller configuration or in a partial playpen configuration; and
a circumferential main curtain spanning between said base and said upper front and upper rear support bars and surrounding said stroller in the playpen configuration or the concealed stroller configuration.

2. A stroller according to claim 1, wherein:
the open ends of said U-shaped bars are hinged at and rotatable about said joint side-hubs, and foldably collapsible about said joint side hubs into a nested arrangement when the stroller in said folded configuration;
said upper rear support bar, lower front support bar and lower rear support bar are rotatably expandable about said joint side hubs into a fully deployed position when the stroller is in said stroller configuration or said playpen configuration; and
when the stroller is in said stroller configuration or said playpen configuration, said upper front support bar is selectively rotatably expandable about said joint side hubs into:
a raised deployed position when fully expanded to render the stroller in a concealed-stroller configuration or in a full playpen configuration; and/or
a lowered deployed position when partially expanded while neighbouring said base, to render the stroller in an open-stroller configuration or in a partial playpen configuration.

3. A stroller according to claim 1, wherein:
the open ends of said upper rear support bar, said lower front support bar, and said lower rear support bar, are hinged at and rotatable about said joint side-hubs, and foldably collapsible about said joint side hubs into a nested arrangement when the stroller in said folded configuration, and are rotatably expandable about said joint side hubs into a fully deployed position when the stroller is in said stroller configuration or said playpen configuration; and
said upper front support bar is telescopically expandable from said lower rear support bar into a raised deployed position when fully expanded to render the stroller in a concealed-stroller configuration or in a full playpen configuration, and is telescopically collapsible with said lower rear support bar into a nested arrangement when the stroller is in said folded configuration, or an open-stroller configuration, or in a partial playpen configuration.

4. A stroller according to claim 1, wherein said joint side hubs comprise joint side hinges.

5. A stroller according to claim 1, further comprising a foldable rest, wherein said upper rear support bar comprises a seat support bridge, and said foldable rest comprises:
a U-shape seat lifting bar, hinged at its ends at least to one of:
rear corners of said base; and
corners of said lower rear support bar; and
a sheet extending between said seat lifting bar and said seat support bridge and comprising a cavity disposed in the upper section of said sheet, said cavity comprising a seat bottom and a seat back support,
wherein said rest is deployed into a sitting mode when said seat lifting bar is lowered to said base when the stroller is in the stroller configuration, and is folded when said seat lifting bar is raised to an uppermost position, when the stroller is in the playpen configuration or the folded configuration.

6. A stroller according to claim 1, wherein said upper rear support bar comprises a handle portion pivotally hinged about side handle hinges, allowing selective erection of said upper rear support bar into a handle position, at a selected angle, when said stroller is in the stroller configuration or the playpen configuration, and folding into a compacted position when the stroller is in the folded configuration.

7. A stroller according to claim 6, wherein said handle portion comprises at least one of:
a handle portion configured as a carrying handle for carrying the stroller in the folded configuration;
a retractable handle portion for adapting to the height of the user; and
a safety latch.

8. A stroller according to claim 1, wherein said joint side hubs comprise a locking mechanism configured to hold said support bars in locked position.

9. A stroller according to claim 1, further comprising left and right complementary curtains for concealing upper gaps between said upper support bars.

10. A stroller according to claim 1, wherein at least one of said main curtain and complementary curtains for concealing upper gaps between said upper support bars, is removably attachable by at least one of:
a zipper;
a set of corresponding fastening strips;
a pair of magnets;
an interlocking buckle; and
a string.

11. A stroller according to claim 1, wherein at least one of said main curtain and complementary curtains for concealing upper gaps between said upper support bars, comprises a curtain selected from the list consisting of:
translucent;
mesh;
transparent;
netted;
liquid resistant;
incorporating child gripping means;
incorporating child climbing means; and
incorporating a closable rear access aperture.

12. A stroller according to claim 1, wherein said base support is hingedly coupled to the lower front support bar and the lower rear support bar and is foldable about an intermediate hinge.

13. A method for converting a convertible stroller for children, between stroller, playpen and folded configurations, the method comprising the procedures of:
moving lower front, lower rear and upper rear U-shaped chassis support bars, whose ends are connected to and movable about, joint side-hubs, to a fully deployed position when fully expanded about said joint side hubs for rendering said convertible stroller in an unfolded configuration, and thereby unfolding of a base support, wherein said support is coupled to said lower front support bar and lower rear support bar, enclosing a covering material;
setting a U-shaped chassis upper front support bar into one of two positions: a raised position for forming a fully erect playpen configuration or a concealed-stroller configuration; and a lowered position for forming a partial playpen configuration or an open-stroller configuration; and
reversing above procedures for folding the convertible stroller into the folded configuration.

14. The method of claim 13 wherein said procedure of moving comprises rotating lower front, lower rear and upper rear U-shaped chassis support bars, whose ends are hinged at, and rotatable about, said joint side-hubs, to a fully deployed position when fully expanded about said joint side hubs for rendering the convertible stroller in an unfolded configuration.

15. The method of claim 13 wherein said procedure of setting comprises rotating a U-shaped chassis upper front support bar, whose ends are hinged at, and rotatable about, said joint side-hubs, into one of two expanded positions: a raised position for forming a fully erect playpen configuration or a concealed-stroller configuration; and a lowered position for forming an open-stroller configuration.

16. The method of claim 13 wherein said joint side hubs comprise joint side hinges.

17. The method of claim 13 further comprising the procedure of deploying a rest in the stroller configuration;

18. The method of claim 17 wherein said procedure of deploying a rest comprises lowering a U-shaped seat lifting bar, hinged at the ends of said seat lifting bar for allowing resting of a child in a stroller configuration.

19. The method of claim 13, further comprising unfolding a handle portion hinged to said upper rear support bar.

20. The method of claim 13, wherein said procedure of unfolding of a base support comprises unfolding said base support about an intermediate hinge.
